(19) United States
(12) Patent Application Publication
(10) Pub. No.: US 2002/0027085 A1
(43) Pub. Date: Mar. 7, 2002

(54) Method for monitoring the quality of electrochemical measuring sensors and a measuring arrangement with an electrochemical measuring sensor

(76) Inventors: Roland Stori, Herisau (CH); Gerhard Kiser, Herisau (CH)

Correspondence Address: SHOEMAKER AND MATTARE, LTD., Bldg. 1, Crystal Plaza Suite 1203, 2001 Jefferson Davis Highway, P.O. Box 2286, Arlington, VA, 22202-0286, US

(21) Appl. No.: 09/823,989

(22) Filed: Apr. 3, 2001

(30) Foreign Application Priority Data
Apr. 4, 2000 (EP) 00810293.1

(51) Int. Cl. G01N 27/26

(52) U.S. Cl. 205/775; 204/401

(57) ABSTRACT

The quality of electrochemical measuring sensors with at least one measuring electrode, for example pH-sensors is checked in that the frequency response of the sensor impedance is measured over a frequency range (f₁, f₂). The frequency response or the value of an equivalent circuit diagram of the measuring circuit (1) computed from the frequency response are compared to reference values. Deviations from the reference values indicate an impairment or damage of the measuring electrode (2). Simultaneously proceeding from the membrane impedance the temperature (T) of the measuring electrode (2) and thus of the measuring fluid (F) is determined.

The invention relates to a method for monitoring the quality of electrochemical measuring sensors and a measuring arrangement with an electrochemical measuring sensor, with the features of the preamble of the indepenedent patent claims.

Measuring sensors are today used for measuring a multitude of chemical or physical variables and are used in a multitude of various embodiment forms.

For example pH-values of measuring fluids are potentiometrically determined with measuring sensors which comprise at least one measuring electrode. With this often glass electrodes are applied. Other sensor types are for example conductivity sensors or platinum-platinum electrodes.

In order to ensure reliable measuring results also over a longer time it is necessary to monitor the quality of the electrode continuously or from time to time. On account of contamination or mechanical damage to the measuring electrode, for example to a glass electrode for a pH-sensor, in the course of time other errors may result with measurements.

It is already known to monitor the quality of measuring electrodes, in particular pH-sensors in that e.g. the impedance of the sensor is determined. The sensor impedance may permit details on the quality of the measuring electrode.

From WO 92/21062 there is for example described a method for error recognition with which error sources occuring in an electrode system may be recognised in the course of a continuous monitoring. For testing, a rectangular impulse is given to the measuring probe. The voltage at the measuring probe to be tested, changed by the probe impedance, is at the same time measured and compared to a nominal value (e.g. to a voltage of an intact measuring probe).

From FR 2762395 it is known to determine the condition of measuring electrodes of a potentiometric measuring system by measuring the impedance of the electrodes. For this there is applied an auxiliary electrode as well as two capacitances. The charging of the capacitances connected to the electrodes which depends on the resistance of the electrodes is determined with this.

From DE 29 42 238 it is known to monitor ion-selective electrodes by using symmetrical, bi-polar current impulses.

The known monitoring methods are all however burdened by certain disadvantages. Thus with the known methods it is not possible to apply a control apparatus which is directed to an electrode type, for operation and for monitoring other electrode types.

Furthermore the determined values are often not accurate enough in order to ensure a reliable quality assurance.

It is therefore the object of the present invention to avoid the disadvantages of that which is known, in particular to provide a method for monitoring electrochemical measuring sensors and a measuring arrangement with an electrochemical measuring sensor which may be used for a plurality of different sensor types, which give reliable monitoring results and which may be realised in a simple manner and without great additional technical expense.

According to the invention these objects are achieved with a method and with a measuring arrangement with the features of the characterising part of the independent patent claims.

In the method according to the invention for monitoring electrochemical measuring sensors which comprise at least one measuring electrode the frequency response of the sensor impedance is measured over a certain frequency range. Measuring sensors are typically pH-sensors which are provided with a glass electrode. Damage to the glass electrode is with this to be detected.

For the frequency response determining, the frequency-dependent impedance and the frequency-dependent phase angle are ascertained.

The sensor consists always of a whole, complete physical system, for example of a pH-electrode, chemical system and reference electrode, a connection cable in the case of a pH-sensor. The frequency response measurement takes into account all these elements. In the case that the electronics are contained in the electrode, the part of the system—the connection cable—is done away with.

The sensor is monitored in that sensor-determining variables are ascertained. One of the variables is the impedance. If the frequency response of the sensor system is measured and analysed from the values determined by way of this, by way of a suitable impedance model and on account of the physical knowledge one may infer the condition of the sensor. In contrast to the known methods the measurement of the frequency response of the sensor impedance permits a more exact determining of the characteristics of the measuring sensor. The values of the measured frequency response or characteristic variables of the sensor computed therefrom are subsequently compared to reference values. The reference values correspond typically to the frequency response of a measuring sensor directly after its production.

According to a preferred embodiment example the frequency response is measured over a large frequency range, typically over a range of 0.1 Hz to 10 kHz. This permits ratings of various sensor types (e.g. pH-electrodes and conductivity-measuring cells) to be determined with the same method or with the same measuring arrangement and for the sensors to be monitored.

This measurement is typically determined at the expected operating temperatures of the sensor, thus for example between 0° C. and 80° C. in approx. 1-3 measurements of the respective frequency response.

From the measured frequency response according to a further embodiment example the values of the elements of an equivalent circuit diagram describing the measuring sensor are determined. The values determined in this manner may then be compared to reference values for the elements of the equivalent circuit diagram of the measuring sensor. The determining of individual values of elements of the measuring sensor permits a more accurate characterisation of the condition of the sensor, in particular of the measuring electrode.

Adavantageously simultaneously for monitoring the quality of the measuring sensor (i.e. for determining the frequency response) the normal sensor signal evaluation is carried out. This in the case of a pH-electrode is a measurement of the electrode potential.

It is furthermore possible, proceeding from the determined sensor impedance, in particular based of the frequency response, to determine the temperature of the measuring electrode and thus the temperature of the fluid to be measured. Advantageously the temperature determining is likewise carried out simultaneously to the normal sensor signal evaluation and to the frequency response analysis.

This means that simultaneously up to three measuring signals are determined and evaluated and that up to three analog/digital conversions are simultaneously carried out.

The measuring data is advantageously transferred from the measuring sensor to a control apparatus via serial interfaces. The control apparatus controls the measuring procedure and indicates the measuring values.

The frequency response analysis (in particular also the advantageous determining of the values of the equivalent circuit corresponding to the sensor) is effected in an evaluation arrangement which may be contained in the control apparatus.

It is furthermore also conceivable to carry out the temperature determining on account of the electrode impedance only at a certain frequency in order to reduce the computation and data transmission effort.

The temperature of the measuring electrode may in particular in the case of a pH-electrode be determined in that on account of the ascertained frequency response of the sensor impedance, the electrical resistance of the sensor membrane is determined, and then proceeding from the resistance of the sensor membrane, the temperature is ascertained.

So that the normal signal evaluation may be carried out simultaneously with the frequency response analysis, the frequency range is preferably selected in a manner such that no polarisation of the measuring electrode occurs, which could disturb or falsify the normal sensor signal evaluation.

The method according to the invention has further additional advantages with respect to the state of the art. Thanks to the determining of the values of the elements of the equivalent circuit diagram, separate quality evidence on the indicator system and the reference system may be made. It is furthermore simultaneously possible (on account of the determined values of the equivalent circuit) to determine the conductivity of the measuring fluid and/or the temperature of the measuring fluid.

According to a further preferred embodiment example it is furthermore also conceivable automatically to produce a warning signal as soon as the deviation between the values of the frequency response and the reference values lies outside a predeterminable tolerance region. For this either the frequency response curve may be compared to a reference curve, or the values of the elements of an equivalent circuit computed from the frequency response be compared to reference values for the elements of the equivalent circuit.

The measuring arrangement according to the invention comprises an electrochemical measuring sensor with at least one measuring electrode. Typically the measuring sensor is a pH-sensor. The measuring arrangement comprises an evaluation arrangement in which there are stored the reference values of the frequency response of the sensor impedance and/or reference values computed therefrom e.g. of the elements of an equivalent circuit of the measuring sensor, at various temperatures.

Parts of the integrated circuit may be arranged directly on the measuring electrode. In this manner the transmisson of the analog, high-resistance signal via special cables is spared. Simultaneously modulated digital signals may be transmitted to the control apparatus. At the control apparatus input there are not necessary any special measures on account of the high-resistance input impedances. I.e. normal double-pole or polypole plugs with shielding may be applied.

The evaluation arrangement further advantageously comprises a control and display apparatus which is galvanically separated from the sensor and preferably also from the integrated circuit.

The measuring arrangement may furthermore be provided with an additional temperature sensor which may serve for the calibration of the temperature measurement via the sensor impedance.

The invention is hereinafter described in more detail by way of the drawings. There are shown in:

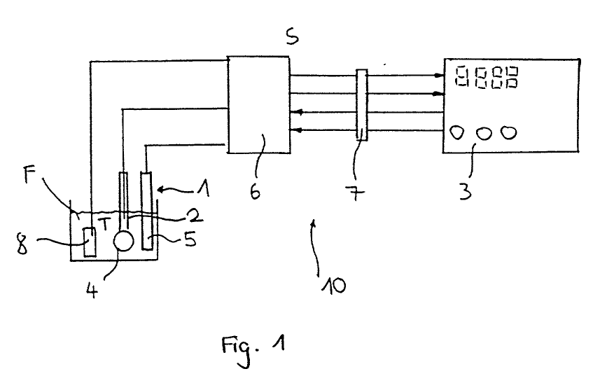

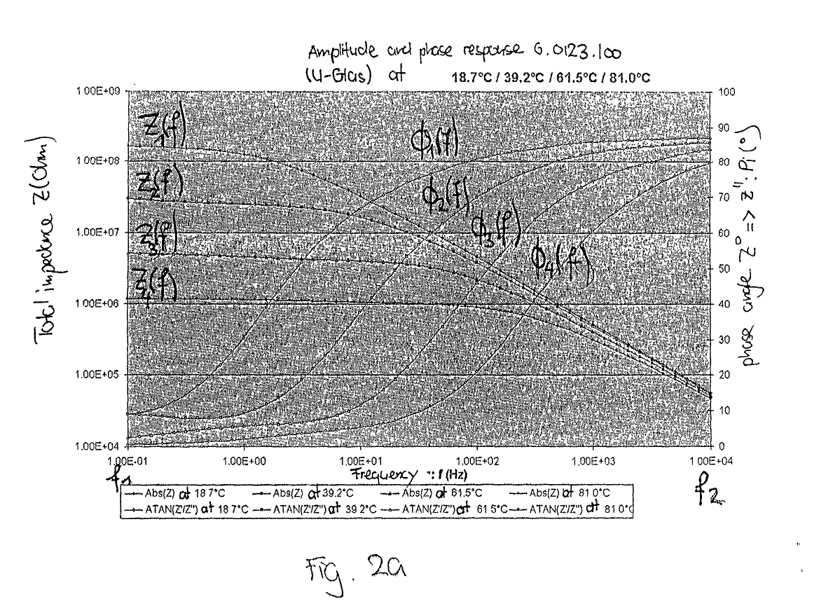

FIG. 1 a schematic representation of the measuring arrangement according to the invention,

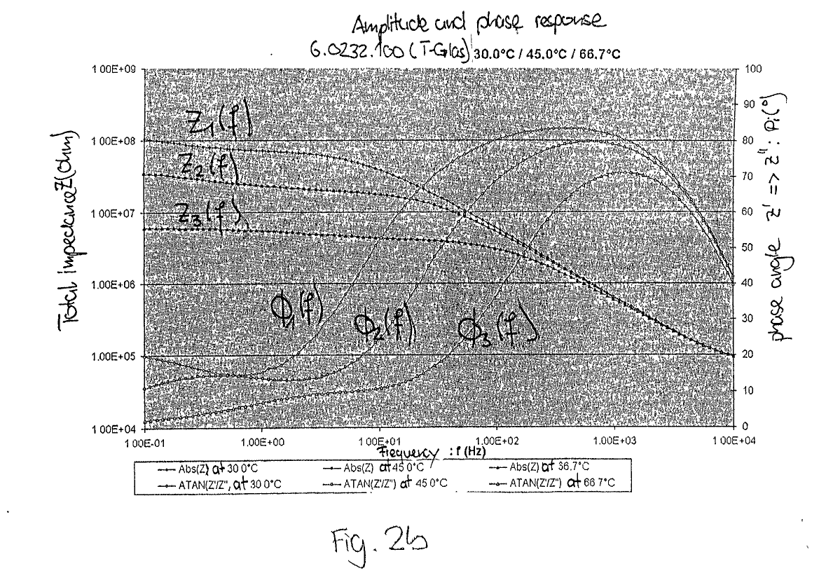

FIGS. 2a and 2b a representation of the amplitude response and phase response of the impedance with two different sensors,

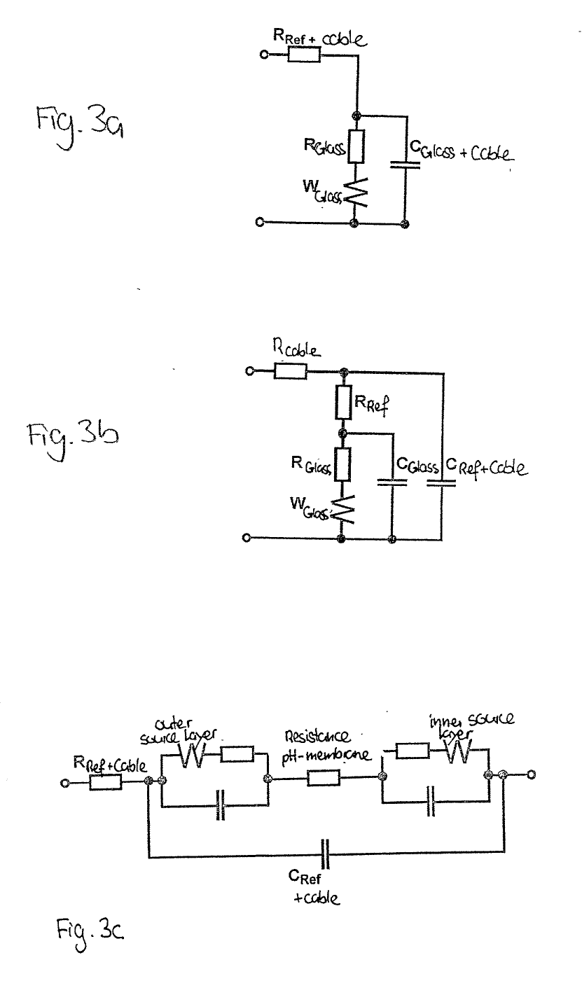

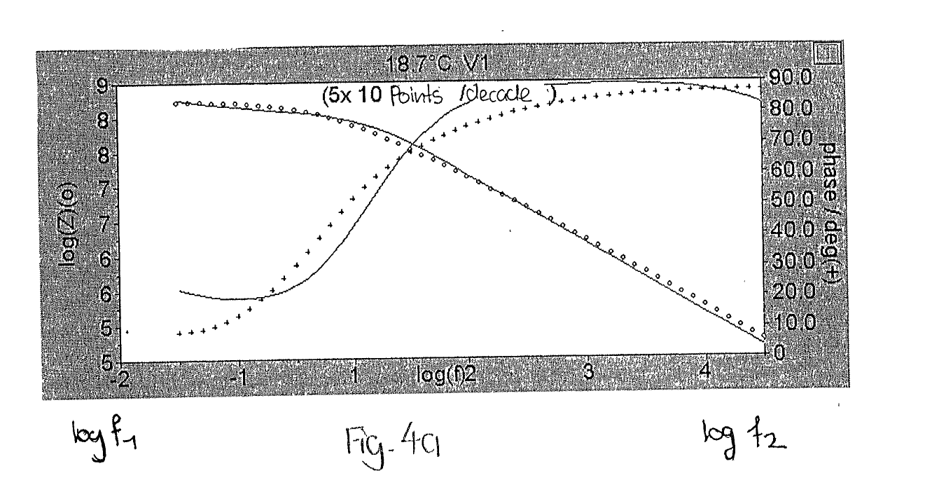

FIGS. 3a to 3c various equivalent diagrams of an electrochemical measuring sensor, and

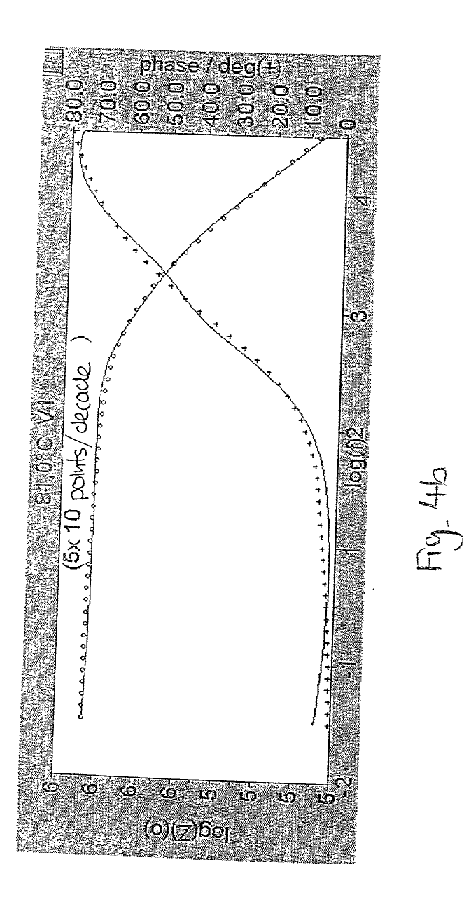

FIGS. 4a and 4b a comparison of the theoretical and measured frequency of response of the sensor impedance at temperatures.

FIG. 1 shows a measuring arrangement 10 according to the invention. The measuring arrangement 10 consists essentially of a measuring sensor 1 and an evaluation arrangement which comprises an integrated circuit 6 and a control and display apparatus 3.

The measuring sensor 1 comprises a measuring electrode 2 and a reference electrode 5. The measuring sensor 1 is designed e.g. as a pH-sensor. The measuring electrode 2 is designed as a glass electrode and comprises a glass membrane 4.

The measuring sensor 1 may furthermore comprise a temperature sensor 8 with which the temperature of the fluid F to be measured may be determined.

The determining of the pH-value of the fluid F is effected in a manner known per se. The method according to the invention may also be applied to other sensors such as e.g. conductivity sensors.

The signals determined in the integrated circuit 6 are subsequently via a serial interface S transferred to the display and control apparatus 3. The connection of the integrated circuit 6 and of the display and control apparatus 3 is effected preferably via a galvanic separation 7, e.g. via an inductive coupling.

The integrated circuit 6 is in FIG. 2 shown separate from the measuring sensor 1 for representational reasons. Advantageously the integrated circuit 6 is however connected to the measuring sensor 1 so that there is formed a functional unit. The application of the integrated circuit 6 permits the determining and evaluation of various measured variables in a particularly simple manner. An ASIC (ASIC Application Specific Integrated Circuit) is applied.

For determining or monitoring the quality of the measuring sensor 1, in particular of the measuring electrode 2 and its glass membrane 4, the frequency response of the sensor is determined over a frequency range f₁, f₂ of typically 0.1 Hz to 10 kHz. With this the frequency response of the impedance Z(f) and the phase Φ(f) is determined. For measuring the frequency response the generator signal is coupled in capacitatively or directly in a DC manner.

In FIGS. 2a and 2b there are represented examples of the amplitude response Z₁, Z₂, Z₃, Z₄ (f) and of the phase response Φ₁(f), Φ₂(f), Φ₃(f), Φ₄(f) of two different measuring sensors at different temperatures.

According to FIG. 2a the impedance response was measured at four various temperatures, T1=18.7° C., T2=39.7° C., T3=61.5° C. and T4=81.0° C. at the pH-glass-electrode (U-glass).

With low frequencies there shows a great temperature dependency of the impedance Z.

In FIG. 2b the impedance response and phase response of an alternative measuring sensor (pH-glass-electrode T-glass) at temperatures of T1=30° C., T2=45° C. and T3=66.7° C. is shown.

From the measured impedance responses and phase responses it is evident that the measured pH-electrodes have a low-pass behaviour. The impedance in the let-through region between 0 and 10 Hz is however not constant but reduces in dependence on √(Iω). This effect is described as the Warburg impedance and shows the dependence of the glass impedance on various frequencies.

In order to obtain as good as possible classification of the quality of the measuring sensor 1, in particular of the measuring electrode 2, from the determined values of the frequency response of the sensor amplitude, the values R_{glass}, W_{glass}, R_{ref}, R_{cable}, C_{glass}, C_{ref}, C_{cable} of elements of an equivalent circuit are computed. According to requirement variously complicated equivalent circuits may be taken into account.

In the FIGS. 3a to 3c there are schematically shown various conceivable equivalent circuits.

A particularly simple equivalent circuit according to FIG. 3 takes into account the resistance component R_{glass} of the membrane glass, the Warburg impedance W_{glass} of the source layers as individual values and the capacitance of the membrane glass C_{glass} and of the connection cable C_{cable} on the one hand, and the resistance of the reference electrode R_{ref} and of the electrode cable R_{cable} on the other hand in each case as common elements. The inner and the outer source layer are with this grouped together to an element.

According to the equivalent circuit diagram from FIG. 3 additional inner and outer source layers of the glass membrane are individually taken into account.

For monitoring the quality of the measuring sensors the impedance of the measuring sensor is measured at various frequencies in a frequency range f₁, f₂.

In FIGS. 4a and 4b there are shown measuring series for a certain sensor system. The measuring points according to FIG. 4 were ascertained at a temperature of 18.7° C., the measuring points according to FIG. 4b at a temperature of 81° C. The measurement was carried out with a pH-electrode 6.0232.100 of Metrohm AG (pH-glass-electrode T-glass).

Proceeding from the individual measuring points, by calculation, for the equivalent circuits shown in the previous figures the values of the elements of the equivalent circuits were determined. From this the theoretical frequency response was determined by calculation. The theoretical frequency response is represented by the unbroken line.

The representation according to FIG. 4 is based on a simple equivalent circuit. FIG. 4 on the more detailed equivalent circuit according to FIG. 3c.

From this it may be concluded that the computation on account of the detailed equivalent circuit yields a better agreement with the effectively measured values.

The values of the equivalent circuit determined by calculation are compared to reference values. As soon as the deviation of the measured values of the equivalent circuit from the reference values is determined, in the display and control apparatus 3 there is produced a signal which displays to the user an impairment or damage to the glass membrane. The reference values are stored in an EEPROM with the integrated circuit 6. The reference values correspond to the values of the elements of the equivalent circuit of the electrode 2 after its production. The reference values are determined by an initial frequency response analysis at various temperatures.

For measuring the temperature of the measuring fluid the temperature dependency of the electrical resistance R_{glass} of the membrane 4 may be used. With a temperature change of approx. 1° C. there reults a resistance change of about 10%. For determining the membrane temperature the same measuring circuit and computing arrangement may be used as for the determining of the amplitude response. The measurement is effected only in a certain frequency range (from 1 to 100 Hz) so that there is effected no polarisation of the electrode. By way of this it is possible to determine the electrode impedance simultaneously with the pH-value.

A higher measuring accuracy may be achieved in that a measuring point is calibrated in the vicinity of the temperature to be measured. In this manner a higher accuracy may be achieved. For calibrating, a temperature sensor (for example NTC or PT1000) may be applied.

In order to carry out the monitoring according to the invention of the measuring sensor 1, after the production of the measuring sensor 1 in a calibration method the measuring sensor 1 must be measured.

In a first step in a frequency response measurement the sensor impedance Z(f) of the measuring sensor 1 is determined. For this the current and phase values at various frequencies are measured. The measurement is effected with a plurality of various, known temperatures over the whole temperature measuring range of the measuring probe 1 (typically from 0 to 80° C.) in a fluid with a good conductability and under exactly defined measuring conditions.

From the measured current values and phase values the frequency response of the impedance is computed.

The measured and computed values (current, phase and impedance) are stored in an EEPROM in the integrated circuit 6 for those frequencies which are used for the temperature determining.

Subsequently for each measured temperature the values of the individual elements R_{glass}, W_{glass}, C_{glass}, R_{ref}, R_{cable} are computed and likewise stored in the EEPROM in the integrated circuit 6.

The electrode quality is regularly determined. The determining of the quality is effected before measurements of the temperature of the measuring fluid or of the actual measuring variable, e.g. the pH-value. For this the following measurements, computation and comparisons are carried out.

The frequency response of the sensor impedance is at a certain known temperature (for example determined with the temperature sensor 8) measured in a predetermined fluid. The frequency range is typically 0.1 Hz to 10 kHz. With the frequency response measurement the current and phase values are measured at the corresponding frequencies.

From the measured current values the frequency-dependent impedance of the measuring sensor 1 is determined.

On account of the frequency response of the sensor impedance the values of the individual elements of a selected equivalent circuit of the electrode 3 are computed. The computation is effected for the known measured tempearture in the given fluid.

The computed values of the elements of the equivalent circuit are compared to the reference values of the equivalent circuit of the electrode after its production which are meauured at a certain temperature and stored. A warning signal is produced in the case that a deviation is ascertained between the computed values and the stored reference values which is too large or not explainable.

Before the membrane glass temperature determining, the electrode base data are calibrated. The values stored in the EEPROM (current, phases, impedance and temperature values) at those frequencies which are to be used for the temperature determining, for this are read from the EEPROM.

The temperature of the measuring fluid is measured as follows via the impedance of the membrane glass:

a) The current value, at a certain frequency which is used for the membrane glass temperature determining, is measured.

b) From the measured current value the impedance at the certain frequency is computed.

c) The temperature T of the measuring fluid F is determined proceeding from the impedance.

1. A method for monitoring electrochemical measuring sensors having at least one measuring electrode, such as pH-sensors, the method comprising the steps of
measuring a frequency response Z(f), Φ(f) of the sensor impedance over a predetermined frequency range whereby frequency response values are generated and
comparing said frequency response values to first reference values.

2. A method according to claim 1, wherein said frequency range is 0.1 Hz to 10 kHz.

3. A method according to claim 1, comprising the further steps of determining values (R_{glass}, C_{glass}, W_{glass}, R_{cable}, R_{ref}, C_{ref}, C_{cable}) of elements of an equivalent circuit describing the measuring sensor on the basis of said frequency response values the and
comparing said values of said elements to second reference values.

4. A method according to one of the claims 1 to 3, wherein a sensor signal is measured and evaluated simultaneously to determining said frequency response.

5. A method according to claim 1, comprising the further steps of determining the temperature (T) of the measuring electrode and thus the temperature (T) of a fluid (F) to be measured based on the sensor impedance (Z), in particular based on the frequency response.

6. A method according to claim 5, using a pH-electrode wherein the electrical resistance R_{glass} of the membrane of the electrode is determined and wherein said temperature is determined based on said electrical resistance.

7. A method according to claim 1, comprising the further step of transferring a sensor signal and signals defining the frequency response via a serial interface to a control apparatus.

8. A method according to claim 1, comprising the further step of producing a warning signal as soon as a deviation between said frequency response values or values computed from said frequency response and said reference values lies outside a predeterminable tolerance region.

9. A method according to claim 1, wherein said frequency range is selected in a manner such that there occurs no polarisation of the measuring electrode.

10. A measuring arrangement with an electrochemical measuring sensor comprising at least one measuring electrode, such as a pH-sensor, and an evaluation arrangement
wherein in the evaluation arrangement there are stored reference values of the frequency response of the sensor impedance and/or reference values of an elements of the equivalent circuit of the measuring sensor computed therefrom.

11. A measuring arrangement according to claim 10, wherein the evaluation arrangement has an integrated circuit.

12. An arrangement according to claim 11, wherein said integrated circui is arranged on the measuring electrode.

13. A measuring arrangement according to claim 10, wherein said evaluation unit has a control and display apparatus which galvanically is separated from the sensor and preferably from the integrated ciruit.

14. A measuring arrangement according to claim 10, wherein the measuring arrangement is provided with a temperature sensor.
